(19) United States
(12) Patent Application Publication
(10) Pub. No.: US 2013/0064915 A1
(43) Pub. Date: Mar. 14, 2013

(54) APPARATUS FOR MANUFACTURING OPTICAL FILM

(71) Applicant: LI-YING WANG HE, Tu-Cheng (TW)

(72) Inventor: LI-YING WANG HE, Tu-Cheng (TW)

(73) Assignee: HON HAI PRECISION INDUSTRY CO., LTD., Tu-Cheng (TW)

(21) Appl. No.: 13/420,555

(22) Filed: Mar. 14, 2012

(30) Foreign Application Priority Data
Sep. 8, 2011 (TW) 100132366

(51) Int. Cl. B29C 47/14

(52) U.S. Cl. 425/174.4

(57) ABSTRACT

An apparatus for manufacturing an optical film includes a first pressing roller, a second pressing roller, an UV solidifying unit and a winding roller. The first pressing roller and the second pressing roller are spaced a predetermined distance from each other and configured for cooperatively molding the optical film by means of microstructures formed on a peripheral surface of the first pressing roller. Reverse-face microstructures are imprinted on the optical film. A diameter of the first pressing roller is smaller than that of the second pressing roller, and a diameter of the winding roller is larger than that of the second pressing roller. The UV solidifying unit is configured for solidifying the molded optical film.

### BACKGROUND

1. Technical Field

The present disclosure relates to an apparatus for manufacturing an optical film.

2. Description of Related Art

To exhibit particular optical effects, many optical films, such as light guide plates (film-shaped), light diffusing sheets, and brightness enhancement films (BEFs), include a number of microstructures with particular functions on a surface thereof. For example, a light guide plate includes a number of microstructures on a surface thereof for dispersing light passing therethrough. The light guide plate with the microstructures can be manufactured by an injection molding method or a printing method.

The printing method of manufacturing an optical film includes following steps: providing a polyester terephthalate (PET) film as a substrate; distributing an ultraviolet (UV) curable glue layer on the PET film; providing at least a pressing roller, which includes a number of microstructures formed on an outer surface thereof; pressing the UV curable glue distributed on the PET film using the pressing roller to form corresponding microstructures on the UV curable glue; exposing the PET film with pressed UV curable glue to UV light to solidify the UV curable glue; finally, winding the solidified UV curable glue onto a reel. However, it is difficult to control the quality of the microstructures formed on the PET. Furthermore, an efficiency of the process of solidifying the UV curable glue is low, therefore, the efficiency of the winding process is decreased.

What is needed, therefore, is an apparatus for manufacturing optical film addressing the limitations described.

### BRIEF DESCRIPTION OF THE DRAWINGS

The components of the drawings are not necessarily drawn to scale, the emphasis instead being placed upon clearly illustrating the principles of the embodiments. Moreover, in the drawings, like reference numerals designate corresponding parts throughout several views.

FIG. 1 is a schematic view of an apparatus for manufacturing optical film, according to an exemplary embodiment of the present disclosure, the apparatus including a first pressing roller.

FIG. 2 is an isometric view of the first pressing roller of FIG. 1.

### DETAILED DESCRIPTION

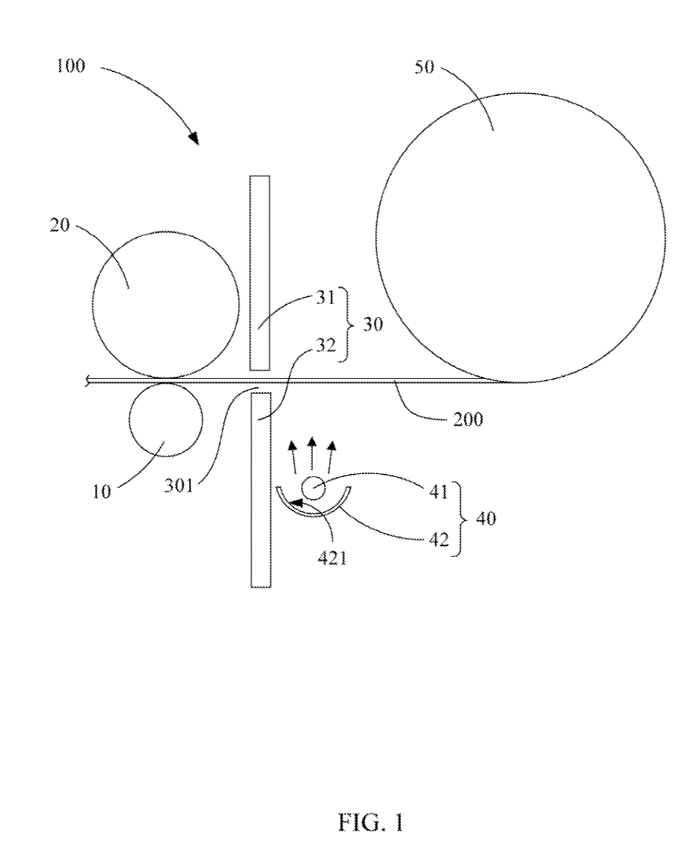

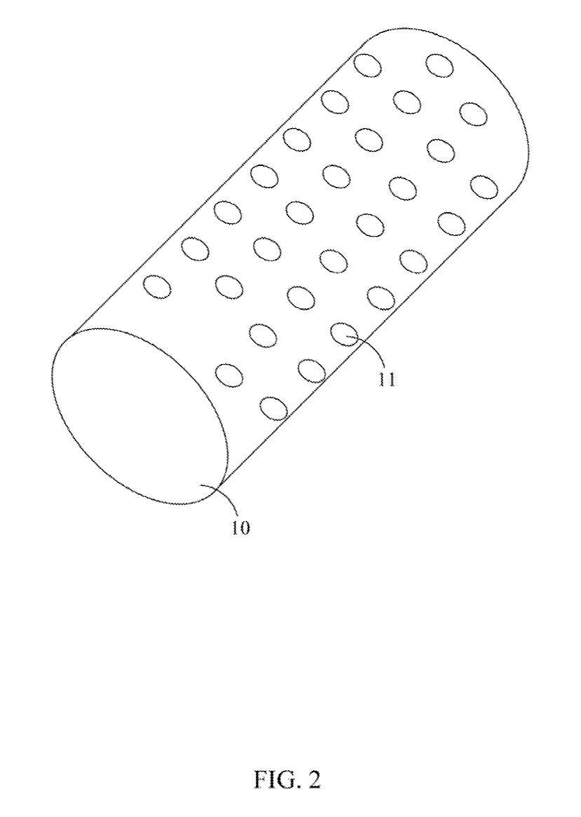

Referring to FIGS. 1-2, an apparatus 100 for manufacturing an optical film, according to an exemplary embodiment, is shown. The apparatus 100 can be used to manufacture light guide plate, light diffusing sheet, BEF, and the like. The optical film employs a polyester terephthalate (PET) layer 200 as a substrate. The apparatus 100 includes a first pressing roller 10, a second pressing roller 20, a light shielding unit 30, an ultraviolet (UV) solidifying unit 40 and a winding roller 50.

The first pressing roller 10 and the second pressing roller 20 are configured for cooperatively molding an optical film. The first pressing roller 10 and the second pressing roller 20 are spaced at a predetermined distance from each other. Referring to FIG. 2, the first pressing roller 10 includes a number of microstructures 11 formed on a peripheral surface thereof. The first pressing roller 10 presses the optical film, and accordingly, the microstructures 11 imprint a number of microstructures on a surface of the optical film. In this embodiment, the microstructures 11 are micro-concaves defined in the peripheral surface of the first pressing roller 30.

The light shielding unit 30 is made from a material that can prevent UV light from passing therethrough. The light shielding unit 30 defines an opening 301 for allowing the moving PET layer to pass therethrough. In this embodiment, the light shielding unit 30 includes a first shielding plate 31 and a second shielding plate 32. The first shielding plate 31 and the second shielding plate 32 are spaced a distance from each other to form the opening 301. Alternatively, the first shielding plate 31 and the second shielding plate 32 are integrally formed, and the opening 301 is a cutout defined in the light shielding unit 30.

The UV solidifying unit 40 is configured for solidifying the molded optical film by directing a beam of UV light onto the film. The UV solidifying unit 40 includes an UV lamp 41 and a reflector 42 located at a side of the UV lamp 41 away from the optical film. The UV lamp 41 is configured for emitting UV light. The reflector 42 is configured for converging UV light emitted by the UV lamp 41 into a beam and guiding the UV light beam onto the optical film. The reflector 42 includes a concave reflecting surface 421 for reflecting UV light emitted by the UV lamp 41. In this embodiment, the reflecting surface 421 is curved.

The winding roller 50 winds the molded and solidified optical film onto itself.

Relative to the second pressing roller 20, the first pressing roller 10 has a smaller diameter, and the winding roller 50 has a larger diameter. In detail, the diameter of the second pressing roller 20 is an integral multiple of that of the first pressing roller 10, and the diameter of the winding roller 50 is an integral multiple of that of the second pressing roller 20. In this embodiment, a ratio of the diameters of the first pressing roller 10, the second pressing roller 20 and the winding roller 50 is 1:2:4 respectively. In one embodiment, the diameter of the first pressing roller 10 is 15 cm, the diameter of the second pressing roller 20 is 30 cm, and the diameter of the winding roller 50 is 60 cm. The small diameter of the first pressing roller 10 allows the number of the microstructures 11 on the first pressing roller 10 to be decreased, and accordingly, the difficulties of precision manufacture of the pressing roller 10 is correspondingly decreased. At the same time, because the number of the microstructures 11 is decreased, an average quality of the microstructures 10 is more easily controlled. The larger diameter of the winding roller reduces the degree of bending or flex of the optical film in the winding process, and damage to the optical film in the winding process is avoided.

The PET layer 200 passes in one direction through the space between the first pressing roller 10 and the second pressing roller 20, the opening 301 of the light shielding unit 30, and is gathered on the winding roller 50.

The first pressing roller 10, the second pressing roller 20 and the winding roller 50 can be rotated by driving motors (not shown).

In use, the first pressing roller 10 starts to rotate clockwise as seen from the view presented in FIG. 1, the second pressing roller 20 starts to rotate anticlockwise, and the winding roller 50 starts to rotate anticlockwise. The UV lamp 42 starts to emit

UV light. UV curable glue is uniformly distributed on the surface of the PET layer 200 which faces the first pressing roller 10. The UV curable glue is distributed on the PET layer 200 by a coater (not shown). The coater is located beside the first pressing roller 10, behind the protection of the light shielding unit 30. The UV curable glue is carried with the PET layer 200 to the space between the first pressing roller 10 and the second pressing roller 20 and is pressed between the first pressing roller 10 and the second pressing roller 20. The first pressing roller 10 imprints microstructures on the UV curable glue corresponding to the microstructures 11 of the pressing roller 10. Then, the UV curable glue with microstructures printed thereon is carried through the opening 301 between the first shielding plate 31 and the second shielding plate 32. As the glue and carrier layer exit through the opening 301, the glue is solidified by UV light emitted by the UV lamp 41. The reflector 42 ensures the intensity and direction of UV light projected onto the UV curable glue, thus the solidifying speed of the UV curable speed can be adjusted. The light shielding unit 30 prevents any premature curing while the UV curable glue is being, or is to be, pressed by the first pressing roller 10 and the second pressing roller 20, to ensure the highest quality of the imprinted microstructures.

It is believed that the present embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

1. An apparatus for manufacturing an optical film, comprising:
a first pressing roller;
a second pressing roller;
an UV solidifying unit; and
a winding roller;
wherein the first pressing roller and the second pressing roller are spaced a predetermined distance from each other and configured for cooperatively molding the optical film, the first pressing roller comprises a plurality of microstructures formed thereon, the microstructures imprint corresponding microstructures on the optical film, a diameter of the first pressing roller is smaller than that of the second pressing roller, a diameter of the winding roller is larger than that of the second pressing roller, the UV solidifying unit is configured for solidifying the molded optical film, and the winding roller is configured for winding molded and solidified optical film thereon, the apparatus further comprises a light shielding unit configured for preventing UV light from passing therethrough, the light shielding unit is located between the first and second pressing rollers and the UV solidifying unit and shields the first and second pressing rollers from the UV light, and the light shielding unit defines an opening for allowing the molded optical film to pass therethrough.

2. The apparatus of claim 1, wherein the microstructures are micro-concaves defined in a peripheral surface of the first pressing roller.

3-4. (canceled)

5. The apparatus of claim 1, wherein the UV solidifying unit comprises an UV lamp and a reflector located at a side of the UV lamp away from the optical film, the UV curable lamp is configured for emitting UV light, the reflector is configured for converging UV light emitted by the UV lamp into a beam and guiding the UV light beam onto the optical film.

6. The apparatus of claim 1, wherein the diameter of the second pressing roller is an integral multiple of that of the first pressing roller, and the diameter of the winding roller is an integral multiple of that of the second pressing roller.

7. The apparatus of claim 1, wherein a ratio of the diameters of the first pressing roller, the second pressing roller and the winding roller is 1:2:4.

8. The apparatus of claim 1, wherein the diameter of the first pressing roller is 15 cm, the diameter of the second pressing roller is 30 cm, and the diameter of the winding roller is 60 cm.

9. The apparatus of claim 1, wherein the light shielding unit is substantially perpendicular to a conveying direction of the optical film.

10. The apparatus of claim 1, wherein the light shielding unit comprises a first shielding plate and a second shielding plate, the first shielding plate and the second shielding plate are spaced a distance from each other to form the opening.
